(19) United States
(12) Patent Application Publication
(10) Pub. No.: US 2023/0086846 A1
(43) Pub. Date: Mar. 23, 2023

(54) RANKING SUGGESTIONS FOR COMPLETING A SEARCH QUERY BASED ON LIKELIHOOD OF A USER INCLUDING ITEMS CORRESPONDING TO THE SUGGESTIONS IN AN ORDER

(71) Applicant: Maplebear Inc. (dba Instacart), San Francisco, CA (US)

(72) Inventors: Tejaswi Tenneti, Fremont, CA (US); Esther Vasiete, Brooklyn, NY (US); Nitin Pasari, San Francisco, CA (US)

(21) Appl. No.: 17/478,411

(22) Filed: Sep. 17, 2021

(51) Int. Cl. G06Q 30/06; G06F 16/2457; G06F 16/9535; G06F 16/9538; G06N 3/08

(52) U.S. Cl. CPC G06Q 30/0631; G06F 16/24578; G06F 16/9535; G06F 16/9538; G06N 3/084

(57) ABSTRACT

An online concierge system displays a search interface to users. The search interface receives s prefix of a search query from a user and determines terms for completing the prefix, with the terms displayed to a user as suggestions via the search interface. The online concierge system determines probabilities of the user adding items corresponding to terms for completing the prefix when different terms are displayed. The online concierge system displays the terms for completing the prefix in an order based on the determined probabilities of including a corresponding item in an order rather than in an order based on likelihoods of the user selecting different terms.

### BACKGROUND

This disclosure relates generally to selecting items from an online concierge system for inclusion in an order, and more specifically to ranking suggestions for completing a search query from a user based on likelihoods of the user including items in an order via the online concierge system.

In current online concierge systems, shoppers (or “pickers”) fulfill orders at a physical warehouse, such as a retailer, on behalf of users as part of an online shopping concierge service. An online concierge system provides an interface to a user identifying items offered by a physical warehouse and receives selections of one or more items for an order from the user. In current online concierge systems, the shoppers may be sent to various warehouses with instructions to fulfill orders for items, and the shoppers then find the items included in a user's order in a warehouse and deliver the items included in the order to a location specified by the user.

To simplify identification and inclusion of items in an order, conventional online concierge systems use one or more autocompletion, or autosuggestion, methods to simplify entry of search queries by users. In conventional autocompletion methods, characters entered into a search bar or other interface elements form a prefix, and an interface displayed by the online concierge system displays suggestions for extending the prefix to a full search query. The suggestions displayed by the interface are ranked. Conventional autocompletion methods typically mine logs of previously received search queries and order the displayed suggestions based on frequencies of occurrence of different search queries. However, leveraging previously received search queries makes the displayed suggestions sensitive to short-term fluctuations in search terms that are received from users, making the displayed suggestions susceptible to being displayed in significantly different orders based on short-term changes in receipt of search terms.

Additionally, conventional autocompletion methods account for likelihoods of users selecting suggestions when ordering the suggestions for display. However, subsequent user actions, such as subsequent selection of content or items after selecting a suggestion are not accounted for by conventional autocompletion method. For many online concierge systems, subsequent selection of an item for purchase has greater significance than the selection of a suggestion for a search query, so ranking of suggestions based on likelihood of being selected by a user to complete a search query displays the suggestions in an order that increases a number of interfaces or a number of inputs for a user to provide before including an item in an order for purchase.

### SUMMARY

To simplify creation of an order by a user, when an online concierge system receives a request for an order from a user, the online concierge system transmits an interface including a search interface to a client device of the user. The search interface receives a prefix comprising set of characters from the user through an input element, such as a search bar, and the online concierge system selects one or more terms to suggest to the user based on the prefix. The online concierge system displays the selected one or more terms as suggestions to the user via the search interface. This allows the user to select a of the displayed terms to include the term selected by the user in a search query, reducing an amount of inputs by the user for the online concierge system to receive a search query

When displaying terms as suggestions to a user, the online concierge system ranks the terms and displays the terms in the search interface in an order based on the ranking. To determine the ranking of the terms for display to the user, the online concierge system leverages previously received search terms to generate and to train a conversion model that determines a probability of a user including an item corresponding to a term in an order when the term is displayed. To generate the conversion model, the online concierge system identifies a warehouse and retrieves prior searches received from users for items offered by the warehouse and previously received orders for items from the warehouse. In some embodiments, the online concierge system retrieves prior searches received from users for items offered by the warehouse and prior orders received from users for items offered by the warehouse.

From the prior searches received from users for items offered by the warehouse and the previously received orders for items from the warehouse, the online concierge system identifies combinations of the warehouse, a term, and a prefix received in a prior search. For a combination of the warehouse, the term, and the prefix received in the prior search, the online concierge system determines features for the combination from prior searches received from users for the warehouse that include the prefix and previously received orders for items that include the item. A feature includes a ratio of a number of previously received orders by the online concierge system identifying the warehouse that included an item corresponding to the term that the online concierge system received after receiving a search including the prefix was included in an order from the warehouse to a number of prior searches for items offered by the warehouse that included the prefix and the term. However, in other embodiments, a feature includes any suitable value determined from a number (or a frequency) of previously received orders identifying the warehouse and including an item corresponding to the term received after the online concierge system received a search including the prefix to a number (or a frequency) of prior searches including the term and the prefix. In various embodiments, the online concierge system determines items corresponding to a term from a taxonomy of items identifying relationships between items and categories or generic item description or other information identifying associations between terms and items offered by the warehouse. In some embodiments, the online concierge system determines multiple features for the combination of the warehouse, the term, and the prefix received in the prior search from numbers (or frequencies) of previously received orders identifying the warehouse that include an item corresponding to the term received after the online concierge system received a search including the prefix during different time intervals to a number (or a frequency) of prior searches including the term and the prefix received during corresponding time intervals. For example, the online concierge system determines a value from a number (or a frequency) of previously received orders identifying the warehouse that include an item corresponding to the term received after the online concierge system received during a specific time interval (e.g., 60 days from a current time) to a number (or a frequency) of prior searches including the term and the prefix received during the specific time interval (e.g., 60 days from the current time) and determines an additional value from a number (or a frequency) of previously received orders identifying the warehouse that include an item corresponding to the term received after the online concierge system received during a different specific time interval (e.g., 30 days from a current time) to a number (or a frequency) of prior searches including the term and the prefix received during the different specific time interval (e.g., 30 days from the current time).

Another feature determined for the combination of the warehouse, the term, and the prefix received in the prior search comprises a rate at which users selected the term in prior searches of items offered by the warehouse including the prefix. In various embodiments, the rate is a ratio of a number of prior searches of items offered by the warehouse including the prefix where a user selected the term to a number of prior searches of items offered by the warehouse including the prefix. As another example, a feature determined for the combination of the warehouse, the term, and the prefix is based on a ratio of a number of orders received by the warehouse including an item corresponding to the term to a number of searches of items offered by the warehouse including the term; in some embodiments, the feature is the ratio of a number of orders received by the warehouse including an item corresponding to the term to a number of searches of items offered by the warehouse including the term. In another example, a feature identifies a number of items included in an order for items from the warehouse that included an item corresponding to the term and that was received after the term was included in a prior search of items offered by the warehouse.

One or more of the determined features for the combination of the warehouse, the term, and the prefix describe one or more relationships between the term and the prefix. For example, a feature indicates whether the prefix fully matches the term; the feature has a value when the prefix fully matches the term and has an alternative value when the prefix does not fully match the term. Another feature specific a percentage of the term matched by the prefix. As another example, a feature indicates whether the prefix matches the start of the term or does not match the start of the term. Additionally, a feature identifies a position in a suggestion region where the term was displayed in the search interface where the prefix was received.

From the features determined for various combinations of the warehouse, the term, and the prefix, the online concierge system generates training data for the conversion model comprising a plurality of examples. Each example includes a combination of the warehouse, the term, and the prefix and a corresponding set of features of the combination. Each example of the training data is labeled with an indication of whether an item corresponding to the term was included in an order received by the online concierge system. Hence, the online concierge system uses inclusion of items associated with a term in a previously received order as the labels for training the conversion model, allowing the online concierge system to leverage historical orders from users to determine information about inclusion of items in orders based on inclusion of terms in search queries by the users.

The online concierge system applies the conversion model to each of a plurality of examples of the training data. For an example of the training data (which includes a combination of the warehouse, the term, and the prefix and a corresponding set of features of the combination), application of the distance prediction model to the example generates a predicted probability of a user including an item corresponding to the term in an order. The online concierge system determines an error term from a difference between the label applied to the example of the training data and the predicted probability of a user including an item corresponding to the term in an order. The error term may be generated through any suitable loss function, or combination of loss functions, in various embodiments. For example, the loss function is a mean squared error between a predicted probability of a user including an item corresponding to the term in an order for an example of the training data and a label applied to the corresponding example of the training data. However, in other embodiments, any loss function or combination of loss functions, may be applied to the predicted probability of a user including an item corresponding to the term in an order for an example and the label applied to the corresponding example of the training data to generate the error term.

In some embodiments, the online concierge system initializes layers of a network comprising the conversion model, applies the conversion model to examples of the training data, and backpropagates the one or more error terms from the label applied to an example of the training data and the predicted probability of a user including an item corresponding to the term in an order corresponding to the example through layers of the network comprising the conversion model. One or more parameters of the network are modified through any suitable technique from the backpropagation of the one or more error terms through the layers of the network. For example, weights between nodes of the network, such as nodes in different layers of the network, are modified to reduce the one or more error terms. The backpropagation of the one or more error terms is repeated by the online concierge system until the one or more loss functions satisfy one or more criteria. For example, the one or more criteria specify conditions for when the backpropagation of the one or more error terms through the layers of the network is stopped. In some embodiments, the online concierge system uses gradient descent or any other suitable process to minimize the one or more error terms in various embodiments.

In response to the one or more loss functions satisfying the one or more criteria and the online concierge system stopping the backpropagation of the one or more error terms, the online concierge system stores the set of parameters for the layers of the network. For example, the online concierge system stores the weights of connections between nodes in the network as the set of parameters of the conversion model in a non-transitory computer readable storage medium. Hence, training of the distance prediction model allows the online concierge system to generate and to store a neural network, or other machine learning model, that generates a predicted probability of a user including an item corresponding to a term in an order when the term is included in a search query. The conversion model may be any machine learning model, such as a neural network, boosted tree, gradient boosted tree or random forest model in various embodiments. In some examples, the conversion model is trained via a XGBoost process when the conversion model is applied to examples of the training data. The online concierge system retrains the conversion model at various intervals, such as at a periodic interval, in various embodiments, allowing the conversion model to account for changes in inclusion of items corresponding to terms in orders received from users over time.

Alternatively, the online concierge system generates the conversion model as a tree based ensemble model combining multiple decision trees. In various embodiments, the online concierge system selects at least a set of examples of the training data (which each include a combination of the warehouse, the term, and the prefix and a corresponding set of features of the combination) and trains a decision tree on each example of the set by applying a decision tree to each example and comparing a predicted probability of a user including an item corresponding to the term of the example in an order from application of the decision tree to an example to a label applied to the example. For example, the decision tree iteratively selects features of an example of the training data and selects a feature causing a loss function to satisfy one or more criteria, for example a feature minimizing a squared error between a predicted probability of a user including the item corresponding to the term of the example from the decision tree and a label applied to the example of the training data. The online concierge system 102 sums the loss function over each example of the set to determine a total loss function and selects a feature having a minimum total loss function across the examples of the training data. Subsequently, the online concierge system splits the examples of the training data into subsets having different values for the selected feature and recursively generates new nodes of the decision tree using the subsets of examples until one or more halting criteria are satisfied (e.g., each leaf node of a decision tree includes a minimum number of examples of the training data).

In some embodiments, the online concierge system trains multiple decision trees in parallel from the examples of the training data, with a different subset of examples of the training data used to train different decision trees, with each decision tree selecting a different set of features of the training data. The subset of the training data used to train a decision tree is grouped based on values for the selected set of features for the decision tree and new nodes of the decision tree are generated using the groups of examples until one or more halting criteria are satisfied (e.g., each leaf node of a decision tree includes a minimum number of examples of the training data). The conversion model comprises the set of trained decision trees, with individual decision trees predicting probability of a user including an item corresponding to a term in an order from the combination of the warehouse, the term, and the prefix and a corresponding set of features of the combination and the conversion model outputting a predicted probability of a user including an item corresponding to a term in an order predicted by at least a threshold number of the decision trees.

As another example, the online concierge system trains multiple decision trees in series, training an initial decision tree as described above and determining a loss function for the initial decision tree based on differences between a predicted probability of a user including an item corresponding to a term of an example and a label applied to the example of the training data. For example, the loss function is a squared error function between the predicted probability for an example of the training data and the label applied to the example of the training data. The online concierge system trains another decision tree based on the results of the loss function for each example of the training data and iteratively trains decision tress, with results of the loss function from a decision tree used to train an immediately subsequent decision tree. For example, a gradient of the loss function from a decision tree is used to train an immediately subsequent decision tree. The online concierge system iteratively trains decision trees from the results of the loss function from another decision tree until a specific number of decision trees are trained or until one or more other halting criteria are satisfied. By iteratively propagating a result of a loss function for a decision tree to a subsequent decision tree, an output of a decision tree compensates for errors from an earlier another tree from which the decision tree receives results of the loss function. The output of the conversion model is a combination (e.g., a sum) of the predicted probability of a user including an item corresponding to a term in an order output by each of the trained decision trees.

After training and storing the trained conversion model, when the online concierge system receives a request for an order from a user, the online concierge system displays a search interface to the user. In response to receiving a prefix from the user via the search interface for a search for the requested order, the online concierge system selects a candidate set of terms. In various embodiments, a candidate term comprises a category or other information from a taxonomy including the prefix or a name of an item obtained from an item catalog of the warehouse identified by the request for the order that includes the prefix. In other examples, the online concierge system selects a candidate term as a previously received search query including the prefix. For each candidate search term, the online concierge system determines a probability of the user including an item corresponding to a candidate term in an order. In various embodiments, the online concierge system applies the trained conversion model to a combination of a warehouse identified by the request for the order, the prefix, and the candidate term for each candidate term, determining probabilities of the user including items corresponding to different candidate terms in an order.

The online concierge system ranks the candidate terms based on their corresponding probabilities and displays at least a subset of the candidate terms to the user via the search interface in an order corresponding to the ranking. For example, the online concierge system displays at least a subset of the candidate items in a suggestion region in the order corresponding to the ranking. In various embodiments, terms with higher probabilities have higher positions in the ranking; hence, terms with high probabilities have higher positions in the order. As the ranking of terms is based on probabilities of a user including an item corresponding to different terms in an order, terms with greater probabilities are displayed in higher, more prominent, positions to the user. This allows a user to more easily identify, and to select, terms for inclusion in a search query that correspond to items more likely to be included in an order, allowing users to more efficiently generate orders for the online concierge system for items likely to be purchased.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is an example of a search interface of a customer mobile application (CMA), according to one embodiment.

FIG. 5 is a flowchart of a method for an online concierge system selecting suggestions for completing a search query, according to one embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

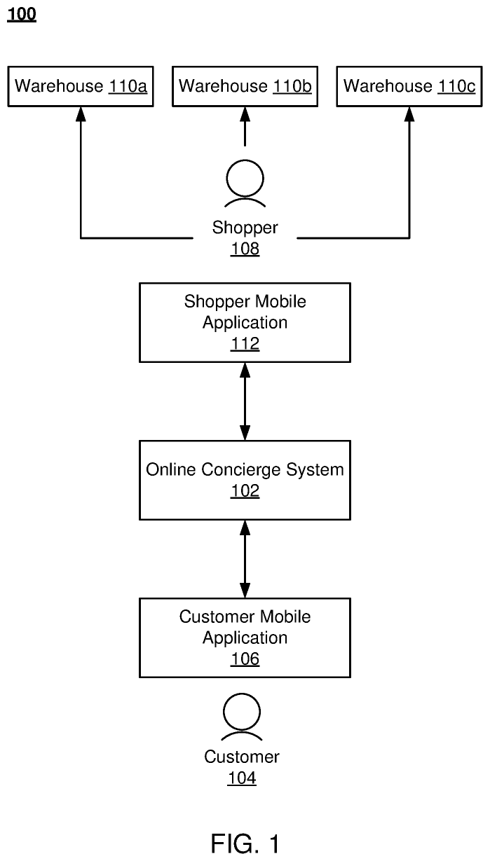

FIG. 1 illustrates an environment 100 of an online platform, according to one embodiment. The figures use like reference numerals to identify elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more users 104 (only one is shown for the sake of simplicity). An order specifies a list of goods (items or products) to be delivered to the user 104. The order also specifies the location to which the goods are to be delivered, and a time window during which the goods should be delivered. In some embodiments, the order specifies one or more retailers from which the selected items should be purchased. The user may use a customer mobile application (CMA) 106 to place the order; the CMA 106 is configured to communicate with the online concierge system 102.

The online concierge system 102 is configured to transmit orders received from users 104 to one or more shoppers 108. A shopper 108 may be a contractor, employee, other person (or entity), robot, or other autonomous device enabled to fulfill orders received by the online concierge system 102. The shopper 108 travels between a warehouse and a delivery location (e.g., the user's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to users. Each shopper 108 fulfills an order received from the online concierge system 102 at one or more warehouses 110, delivers the order to the user 104, or performs both fulfillment and delivery. In one embodiment, shoppers 108 make use of a shopper mobile application 112 which is configured to interact with the online concierge system 102.

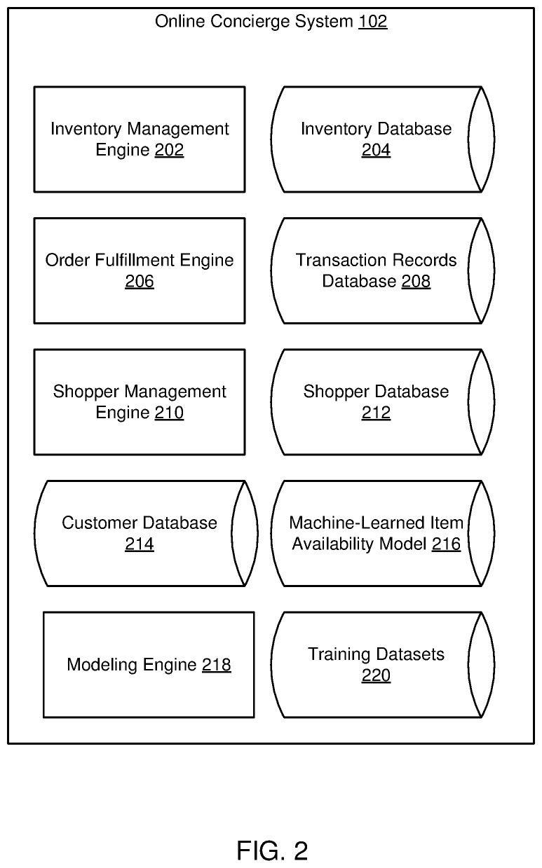

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

The online concierge system 102 also includes an order fulfillment engine 206 which is configured to synthesize and display an ordering interface to each user 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a user 104. Prices set by the order fulfillment engine 206 may or may not be identical to in-store prices determined by retailers (which is the price that users 104 and shoppers 108 would pay at the retail warehouses). The order fulfillment engine 206 also facilitates transactions associated with each order. In one embodiment, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

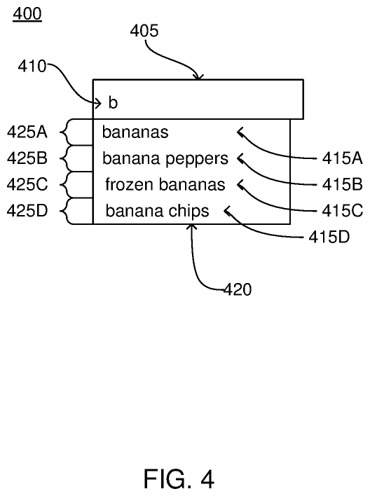

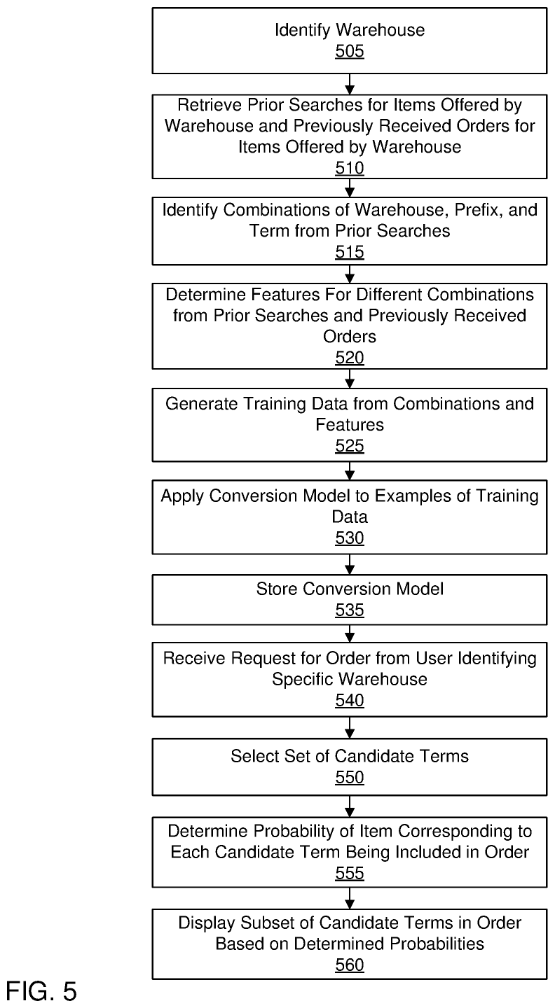

In various embodiments, the order fulfillment engine 206 generates and transmits a search interface, such as the search interface described below in conjunction with FIG. 4, to a client device of a user for display via the customer mobile application 106. The order fulfillment engine 206 receives a prefix, comprising a set of characters, from the user via the search interface and identify a set of terms for a search query based on the prefix. In various embodiments, the terms selected by the order fulfillment engine include the prefix or include a portion of the prefix. In various embodiments, the order fulfillment engine 206 displays multiple terms to the user as suggestions for completing a search query corresponding to a received prefix and determines an order in which the terms are displayed via the customer mobile application 106. As further described below in conjunction with FIG. 5, when determining an order in which to display the terms, the order fulfillment engine 206 accounts for probabilities of the user including an item corresponding to different terms in an order. Hence, in various embodiments, the order fulfillment engine 206 displays terms in an order where terms corresponding to terms having higher probabilities of being included in an order have higher positions in the order, increasing visibility of those terms to the user via the customer mobile application 106.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and user 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the user 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a user database 214 which stores information describing each user. This information could include each user's name, address, gender, shopping preferences, favorite items, stored payment instruments, and so on.

### Machine Learning Models

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a user or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the user 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220.

Additionally, in various embodiments the training datasets 220 include training data describing orders previously received from users and prior searches of items offered by various warehouses 110. For example, training data identifies a prefix received for a search, a term selected for the search, and a warehouse 110 for which the search was received. As another example, the training data identifies a prefix received for a search, a term selected for the search, a warehouse 110 for which the search was received, and information describing an order received subsequent to the search (e.g., items included in the order, a number of items included in the order, etc.). The prior searches and previously received orders allow the online concierge system 102 to determine an order in which to display terms as suggestions for a search that accounts for frequencies or likelihoods of items corresponding to different terms being included in an order after a search is received, as further described below in conjunction with FIG. 5.

The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 maintains a trained conversion model that determines a probability of a user including an item corresponding to a term in an order when the term is displayed. In various embodiments, the conversion model receives a combination of a warehouse 110, a term, and a prefix received in a prior search, as well as a set of features for the combination from prior searches received from users for the warehouse 110 that include the prefix and previously received orders for items that include an item corresponding to the term. As further described below in conjunction with FIG. 5, the distance prediction model accounts for prior inclusion of items in orders from the warehouse that were received after searches including various terms were received, providing a probability of a user including an item in an order after the user inputs a search including a term. This allows the online concierge system 102 to account for effects of different terms in searches on subsequent inclusion of items in orders when determining an order in which to present terms to a user, allowing such presentation of terms to more prominently display terms with higher probabilities of the user subsequently including an item in an order.

### Machine-Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

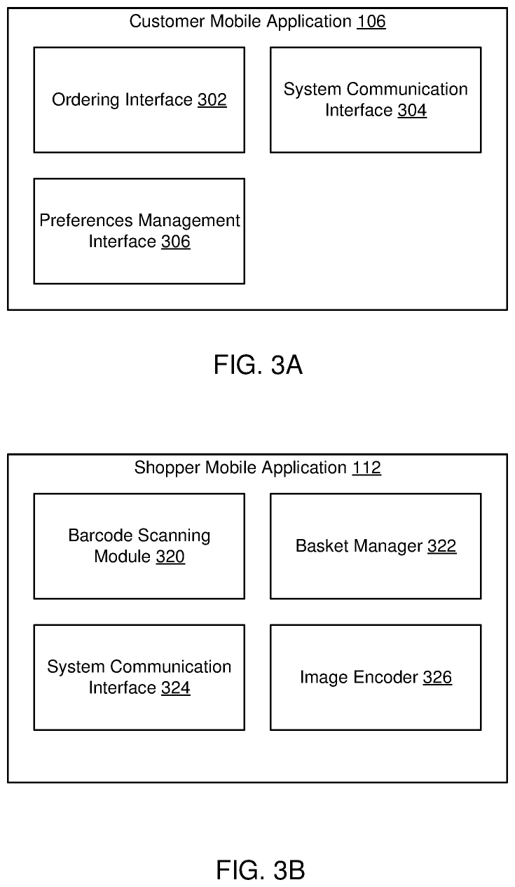

FIG. 3A is a diagram of the customer mobile application (CMA) 106, according to one embodiment. The CMA 106 includes an ordering interface 302, which provides an interactive interface with which the user 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the user 104 to manage basic information associated with his/her account, such as his/her home address and payment instruments. The preferences management interface 306 may also allow the user to manage other details such as his/her favorite or preferred warehouses 110, preferred delivery times, special instructions for delivery, and so on.

In various embodiments, the ordering interface 302 includes a search interface configured to receive a search query from a user. The online concierge system 102 identifies one or more items satisfying the received search query and displays information about the identified items to the user via the CMA 106, allowing the user to more easily identify items offered by a warehouse 110. To simplify entry of a search query, the online concierge system 102 displays suggestions of terms for the search query to the user as the online concierge system 102 receives portions of terms comprising the search query, allowing the user to select a suggestion to provide a search query by selecting a suggestion.

FIG. 4 is one example of a search interface 400 of a customer mobile application (CMA) 106. In various embodiments, the search interface 400 is displayed in conjunction with additional content, so the search interface 400 comprises a portion of a larger interface displayed by the CMA 106. However, in other embodiments, the search interface 400 is an independent interface displayed by the CMA 106.

The search interface 400 includes an input element 405, such as a search bar, configured to receive text input from a user. Text entered into the input element 405 by the user forms a prefix 410 that is a set of one or more characters received from the user. The prefix 410 is updated as the input element 405 receives text, so the prefix 405 is adjusted or modified as the user provides input to the input element 405. The online concierge system 102 identifies one or more terms 415A, 415B, 415C, 415D (also referred to individually and collectively using reference number 415) based on the received prefix 410. The search interface 400 displays the terms 415 in a suggestion region 420 configured to receive user input. An input to the suggestion region 420 allows the user to select a term 415, which replaces the prefix 410 in the input element 410 with the term 415 selected by the user. This allows the online concierge system 102 to simplify user entry of a search query by allowing the user to select a term 415 from the suggestion region 420 rather than manually enter the term 415 in its entirety.

The suggestion region 420 includes different positions 425A, 425B, 425C, 425D (also referred to individually and collectively using reference number 425) in which terms 415 are displayed. Each position 425 displays a single term 415, and the online concierge system 102 determines ranking for the terms 415 and displays the terms 415 so a position 425 in the suggestion region 420 for the term corresponds to a position in the ranking for the term 415. As further described below in conjunction with FIG. 5, the online concierge system 102 ranks the terms 415 based on likelihoods of the user adding an item corresponding to a term 415 to an order, so terms 415 with higher likelihoods of the user adding a corresponding item to an order have higher positions in the ranking. This allows the suggestion region 420 to display terms 415 corresponding to higher likelihoods of users including an item in an order in more prominent (i.e., higher) positions 425 in the suggestion region 420.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from system 102 and transmits the contents of a basket of items to system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Ranking Suggested Terms for Search Queries by Likelihood of Inclusion of Items in an Order

FIG. 5 is a flowchart of one embodiment of a method for an online concierge system 102 ranking suggested terms for completing a search query based on likelihoods of a user including items corresponding to suggested terms in an order. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the online concierge system 102 in various embodiments.

To simplify creation of an order by a user, when an online concierge system 102 receives a request for an order from a user, the online concierge system 102 transmits an interface including a search interface, as further described above in conjunction with FIG. 4, to a client device of the user. The search interface receives a prefix comprising set of characters from the user through an input element, such as the search bar shown in FIG. 4. The online concierge system 102 selects one or more terms to suggest to the user based on the prefix and displays the selected one or more terms as suggestions to the user via the search interface. This allows the user to select a of the displayed terms to include the term selected by the user in a search query, reducing an amount of inputs by the user for the online concierge system 102 to receive a search query

When displaying terms as suggestions to a user, the online concierge system 102 ranks the terms and displays the terms in the search interface in an order based on the ranking. To determine the ranking of the terms for display to the user, the online concierge system 102 leverages previously received search terms to generate and to train a conversion model that determines a probability of a user including an item corresponding to a term in an order when the term is displayed. To generate the conversion model, the online concierge system 102 identifies 505 a warehouse 110 and retrieves 510 prior searches received from users for items offered by the warehouse 110 and previously received orders for items from the warehouse 110. In some embodiments, the online concierge system 102 retrieves 510 prior searches received from users for items offered by the warehouse 110 and prior orders received from users for items offered by the warehouse 110.

From the prior searches received from users for items offered by the warehouse 110 and the previously received orders for items from the warehouse 110, the online concierge system 102 identifies 515 combinations of the warehouse 110, a term, and a prefix received in a prior search. For a combination of the warehouse 110, the term, and the prefix received in the prior search, the online concierge system 102 determines 520 features for the combination from prior searches received from users for the warehouse 110 that include the prefix and previously received orders for items that include the item. A feature includes a ratio of a number of previously received orders by the online concierge system 102 identifying the warehouse 110 that included an item corresponding to the term that the online concierge system received after receiving a search including the prefix was included in an order from the warehouse 110 to a number of prior searches for items offered by the warehouse 110 that included the prefix and the term. However, in other embodiments, a feature includes any suitable value determined from a number (or a frequency) of previously received orders identifying the warehouse 110 and including an item corresponding to the term received after the online concierge system 102 received a search including the prefix to a number (or a frequency) of prior searches including the term and the prefix. In various embodiments, the online concierge system 102 determines items corresponding to a term from a taxonomy of items identifying relationships between items and categories or generic item description or other information identifying associations between terms and items offered by the warehouse 110. In some embodiments, the online concierge system 102 determines 520 multiple features for the combination of the warehouse 110, the term, and the prefix received in the prior search from numbers (or frequencies) of previously received orders identifying the warehouse 110 that include an item corresponding to the term received after the online concierge system 102 received a search including the prefix during different time intervals to a number (or a frequency) of prior searches including the term and the prefix received during corresponding time intervals. For example, the online concierge system 102 determines a value from a number (or a frequency) of previously received orders identifying the warehouse 110 that include an item corresponding to the term received after the online concierge system 102 received during a specific time interval (e.g., 60 days from a current time) to a number (or a frequency) of prior searches including the term and the prefix received during the specific time interval (e.g., 60 days from the current time) and determines an additional value from a number (or a frequency) of previously received orders identifying the warehouse 110 that include an item corresponding to the term received after the online concierge system 102 received during a different specific time interval (e.g., 30 days from a current time) to a number (or a frequency) of prior searches including the term and the prefix received during the different specific time interval (e.g., 30 days from the current time).

Another feature determined 520 for the combination of the warehouse 110, the term, and the prefix received in the prior search comprises a rate at which users selected the term in prior searches of items offered by the warehouse 110 including the prefix. In various embodiments, the rate is a ratio of a number of prior searches of items offered by the warehouse 110 including the prefix where a user selected the term to a number of prior searches of items offered by the warehouse including the prefix. As another example, a feature determined for the combination of the warehouse 110, the term, and the prefix is based on a ratio of a number of orders received by the warehouse 110 including an item corresponding to the term to a number of searches of items offered by the warehouse 110 including the term; in some embodiments, the feature is the ratio of a number of orders received by the warehouse 110 including an item corresponding to the term to a number of searches of items offered by the warehouse 110 including the term. In another example, a feature identifies a number of items included in an order for items from the warehouse 110 that included an item corresponding to the term and that was received after the term was included in a prior search of items offered by the warehouse 110.

One or more of the determined features for the combination of the warehouse 110, the term, and the prefix describe one or more relationships between the term and the prefix. For example, a feature indicates whether the prefix fully matches the term; the feature has a value when the prefix fully matches the term and has an alternative value when the prefix does not fully match the term. Another feature specific a percentage of the term matched by the prefix. As another example, a feature indicates whether the prefix matches the start of the term or does not match the start of the term. Additionally, a feature identifies a position in a suggestion region where the term was displayed in the search interface where the prefix was received.

From the features determined 520 for various combinations of the warehouse 110, the term, and the prefix, the online concierge system 102 generates 525 training data for the conversion model comprising a plurality of examples. Each example includes a combination of the warehouse 110, the term, and the prefix and a corresponding set of features of the combination. Each example of the training data is labeled with an indication of whether an item corresponding to the term was included in an order received by the online concierge system 102. Hence, the online concierge system 102 uses inclusion of items associated with a term in a previously received order as the labels for training the conversion model, allowing the online concierge system 102 to leverage historical orders from users to determine information about inclusion of items in orders based on inclusion of terms in search queries by the users.

The online concierge system 102 applies 530 the conversion model to each of a plurality of examples of the training data. For an example of the training data (which includes a combination of the warehouse 110, the term, and the prefix and a corresponding set of features of the combination), application of the distance prediction model to the example generates a predicted probability of a user including an item corresponding to the term in an order. The online concierge system 102 determines an error term from a difference between the label applied to the example of the training data and the predicted probability of a user including an item corresponding to the term in an order. The error term may be generated through any suitable loss function, or combination of loss functions, in various embodiments. For example, the loss function is a mean squared error between a predicted probability of a user including an item corresponding to the term in an order for an example of the training data and a label applied to the corresponding example of the training data. However, in other embodiments, any loss function or combination of loss functions, may be applied to the predicted probability of a user including an item corresponding to the term in an order for an example and the label applied to the corresponding example of the training data to generate the error term.

The online concierge system 102 initializes layers of a network comprising the conversion model, applies 530 the conversion model to examples of the training data, and backpropagates the one or more error terms from the label applied to an example of the training data and the predicted probability of a user including an item corresponding to the term in an order corresponding to the example through layers of the network comprising the conversion model. One or more parameters of the network are modified through any suitable technique from the backpropagation of the one or more error terms through the layers of the network. For example, weights between nodes of the network, such as nodes in different layers of the network, are modified to reduce the one or more error terms. The backpropagation of the one or more error terms is repeated by the online concierge system 102 until the one or more loss functions satisfy one or more criteria. For example, the one or more criteria specify conditions for when the backpropagation of the one or more error terms through the layers of the network is stopped. In some embodiments, the online concierge system 102 uses gradient descent or any other suitable process to minimize the one or more error terms in various embodiments.

In response to the one or more loss functions satisfying the one or more criteria and the online concierge system 102 stopping the backpropagation of the one or more error terms, the online concierge system 102 stores the set of parameters for the layers of the network. For example, the online concierge system 102 stores the weights of connections between nodes in the network as the set of parameters of the conversion model in a non-transitory computer readable storage medium. Hence, training of the distance prediction model allows the online concierge system 102 to generate and to store a neural network, or other machine learning model, that generates a predicted probability of a user including an item corresponding to a term in an order when the term is included in a search query. The conversion model may be any machine learning model, such as a neural network, boosted tree, gradient boosted tree or random forest model in various embodiments. In some examples, the conversion model is trained via a XGBoost process when the conversion model is applied 530 to examples of the training data. The online concierge system 102 retrains the conversion model at various intervals, such as at a periodic interval, in various embodiments, allowing the conversion model to account for changes in inclusion of items corresponding to terms in orders received from users over time.

Alternatively, the online concierge system 102 generates the conversion model as a tree based ensemble model combining multiple decision trees. In various embodiments, the online concierge system 102 selects at least a set of examples of the training data (which each include a combination of the warehouse 110, the term, and the prefix and a corresponding set of features of the combination) and trains a decision tree on each example of the set by applying a decision tree to each example and comparing a predicted probability of a user including an item corresponding to the term of the example in an order from application of the decision tree to an example to a label applied to the example. For example, the decision tree iteratively selects features of an example of the training data and selects a feature causing a loss function to satisfy one or more criteria, for example a feature minimizing a squared error between a predicted probability of a user including the item corresponding to the term of the example from the decision tree and a label applied to the example of the training data. The online concierge system 102 sums the loss function over each example of the set to determine a total loss function and selects a feature having a minimum total loss function across the examples of the training data. Subsequently, the online concierge system 102 splits the examples of the training data into subsets having different values for the selected feature and recursively generates new nodes of the decision tree using the subsets of examples until one or more halting criteria are satisfied (e.g., each leaf node of a decision tree includes a minimum number of examples of the training data).

In some embodiments, the online concierge system 102 trains multiple decision trees in parallel from the examples of the training data, with a different subset of examples of the training data used to train different decision trees, with each decision tree selecting a different set of features of the training data. The subset of the training data used to train a decision tree is grouped based on values for the selected set of features for the decision tree and new nodes of the decision tree are generated using the groups of examples until one or more halting criteria are satisfied (e.g., each leaf node of a decision tree includes a minimum number of examples of the training data). The conversion model comprises the set of trained decision trees, with individual decision trees predicting probability of a user including an item corresponding to a term in an order from the combination of the warehouse 110, the term, and the prefix and a corresponding set of features of the combination and the conversion model outputting a predicted probability of a user including an item corresponding to a term in an order predicted by at least a threshold number of the decision trees.

As another example, the online concierge system 102 trains multiple decision trees in series, training an initial decision tree as described above and determining a loss function for the initial decision tree based on differences between a predicted probability of a user including an item corresponding to a term of an example and a label applied to the example of the training data. For example, the loss function is a squared error function between the predicted probability for an example of the training data and the label applied to the example of the training data. The online concierge system 102 trains another decision tree based on the results of the loss function for each example of the training data and iteratively trains decision tress, with results of the loss function from a decision tree used to train an immediately subsequent decision tree. For example, a gradient of the loss function from a decision tree is used to train an immediately subsequent decision tree. The online concierge system 102 iteratively trains decision trees from the results of the loss function from another decision tree until a specific number of decision trees are trained or until one or more other halting criteria are satisfied. By iteratively propagating a result of a loss function for a decision tree to a subsequent decision tree, an output of a decision tree compensates for errors from an earlier another tree from which the decision tree receives results of the loss function. The output of the conversion model is a combination (e.g., a sum) of the predicted probability of a user including an item corresponding to a term in an order output by each of the trained decision trees.

After training and storing 535 the trained conversion model, when the online concierge system 102 receives 540 a request for an order from a user identifying a specific warehouse 110, the online concierge system 102 displays a search interface, such as the interface described above in conjunction with FIG. 4 to the user. In response to receiving 545 a prefix from the user via the search interface for a search for the requested order, the online concierge system 102 selects 550 a set of candidate terms. In various embodiments, a candidate term comprises a category or other information from a taxonomy including the prefix or a name of an item obtained from an item catalog of the warehouse 110 identified by the request for the order that includes the prefix. In other examples, the online concierge system 102 selects 550 a candidate term as a previously received search query including the prefix. For each candidate search term, the online concierge system 102 determines 555 a probability of the user including an item corresponding to a candidate term in an order. In various embodiments, the online concierge system 102 applies the trained conversion model to a combination of a warehouse 110 identified by the request for the order, the prefix, and the candidate term for each candidate term, determining 555 probabilities of the user including items corresponding to different candidate terms in an order.

The online concierge system 102 ranks the candidate terms based on their corresponding probabilities and displays 560 at least a subset of the candidate terms to the user via the search interface in an order corresponding to the ranking. For example, the online concierge system 102 displays 560 at least a subset of the candidate items in a suggestion region, as described above in conjunction with FIG. 4, in the order corresponding to the ranking. In various embodiments, terms with higher probabilities have higher positions in the ranking; hence, terms with high probabilities have higher positions in the order. As the ranking of terms is based on probabilities of a user including an item corresponding to different terms in an order, terms with greater probabilities are displayed in higher, more prominent, positions to the user. This allows a user to more easily identify, and to select, terms for inclusion in a search query that correspond to items more likely to be included in an order, allowing users to more efficiently generate orders for the online concierge system for items likely to be purchased.

Referring to FIG. 4, application of the method described in conjunction with FIG. 5 results in display of term 415A in position 425A of the suggestion region 420 because term 415A has a maximum probability of the user subsequently including an item corresponding to term 415A in an order. Similarly, terms 415D is displayed in position 425D to account for its lower probability of the user subsequently including an item corresponding to term 415D in an order. As the conversion model accounts for a warehouse 110, the display of terms 415 in positions 425 of the search interface may differ for different warehouses 110 to account for differences in prior purchases of items from and receipt of terms 415 for searches of different warehouses 110.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A conversion model stored on a non-transitory computer readable storage medium, wherein the conversion model is manufactured by a process comprising:
obtaining training data comprising a plurality of examples, each example comprising a combination of a warehouse, a term, a prefix received in a prior search, a corresponding set of features of the combination, and a label applied to each example indicating whether an item corresponding to the term was included in a prior order received by an online concierge system;
initializing a network that comprises a plurality of layers of a neural network, where the conversion model is configured to receive a prefix from a search, the term, the warehouse, and a set of features of a combination of the prefix from the search, the term, and the warehouse and to generate a predicted probability of the item corresponding to the term being included in an order received by the online concierge system;
for each of a plurality of the examples of the training data:
applying the network to the combination of the warehouse, the term, the prefix received in the prior search, and the corresponding set of features of the combination;
backpropagating one or more error terms obtained from one or more loss functions to update a set of parameters of the user interaction network, the backpropagating performed through the neural network and one or more of the error terms based on a difference between a label applied to the example and the predicted probability of the item corresponding to the term being included in an order received by the online concierge system;
stopping the backpropagation after the one or more loss functions satisfy one or more criteria; and
storing the set of parameters of the layers of the network on the computer readable storage medium as parameters of the conversion model.

2. The conversion model of claim 1, wherein a feature of the set comprises a value determined from a number of previously received orders identifying the warehouse including the item corresponding to the term after the online concierge system received a search including the prefix and a number of prior searches for items offered by the warehouse that included the prefix and the term received by the online concierge system.

3. The conversion model of claim 1, wherein the value comprises a ratio of the number of previously received orders identifying the warehouse including the item corresponding to the term after the online concierge system received the search including the prefix to the number of prior searches for items offered by the warehouse that included the prefix and the term received by the online concierge system

4. The conversion model of claim 1, wherein a feature of the set comprises a value determined from a number of previously received orders identifying the warehouse including the item corresponding to the term after the online concierge system received a search including the prefix received during a specific time interval and a number of prior searches for items offered by the warehouse that included the prefix and the term received by the online concierge system during the specific time interval and another feature of the set comprises an additional value determined from a number of previously received orders identifying the warehouse including the item corresponding to the term after the online concierge system received a search including the prefix received during a different specific time interval and a number of prior searches for items offered by the warehouse that included the prefix and the term received by the online concierge system during the different specific time interval.

5. The conversion model of claim 1, wherein a feature of the set comprises a ratio of a number of orders received by the warehouse including the item corresponding to the term to a number of searches of items offered by the warehouse including the term.

6. The conversion model of claim 1, wherein a feature of the set comprises a number of items included in an order for items from the warehouse that included an item corresponding to the term and that was received after the term was included in a prior search of items offered by the warehouse.

7. The conversion model of claim 1, wherein a feature of the set is selected from a group consisting of: a rate at which users selected the term in prior searches of items offered by the warehouse including the prefix, an indication whether the prefix fully matches the term, a percentage of the term matched by the prefix, a position in a suggestion region where the term was displayed when the prefix was received, and any combination thereof.

8. A computer program product comprising a non-transitory computer readable storage medium having instructions encoded thereon that, when executed by a processor, cause the processor to:
access a conversion model that is configured to receive a prefix from a search, a term, the warehouse, and a set of features of a combination of the prefix from the search, the term, and the warehouse and is trained from prior orders and searches received by an online concierge system to output a predicted probability of the item corresponding to the term being included in an order received by the online concierge system from prior receive, at the online concierge system, a request for an order that identifies a specific warehouse;
receive a prefix for a search for the requested order from the user;
select a set of candidate terms based on the prefix for the search for the requested order;
apply the conversion model to each combination of specific warehouse, prefix for the search for the requested order, and candidate term to generate a predicted probability of an item corresponding to a candidate term being included in the requested order; and
display candidate terms to the user in an order based on the predicted probabilities of items corresponding to candidate terms being included in the requested order.

9. The computer program product of claim 8, wherein display candidate terms to the user in the order based on the predicted probabilities of item corresponding to candidate terms being included in the requested order comprises:
rank the candidate terms based on corresponding probabilities of the item corresponding to the candidate term being included in the requested order so candidate terms with higher corresponding probabilities have higher positions in the ranking; and
display the candidate terms to the user in an order based on the rank.

10. The computer program product of claim 8, wherein display candidate terms to the user in the order based on the predicted probabilities of item corresponding to candidate terms being included in the requested order comprises:
display the candidate terms to the user in a suggestion region displayed proximate to an input element that received the prefix for the search for the requested order.

11. The computer program product of claim 8, wherein a feature of the set comprises a value determined from a number of previously received orders identifying the warehouse including the item corresponding to the term after the online concierge system received a search including the prefix and a number of prior searches for items offered by the warehouse that included the prefix and the term received by the online concierge system.

12. The computer program product of claim 8, wherein the value comprises a ratio of the number of previously received orders identifying the warehouse including the item corresponding to the term after the online concierge system received the search including the prefix to the number of prior searches for items offered by the warehouse that included the prefix and the term received by the online concierge system

13. The computer program product of claim 8, wherein a feature of the set comprises a value determined from a number of previously received orders identifying the warehouse including the item corresponding to the term after the online concierge system received a search including the prefix received during a specific time interval and a number of prior searches for items offered by the warehouse that included the prefix and the term received by the online concierge system during the specific time interval and another feature of the set comprises an additional value determined from a number of previously received orders identifying the warehouse including the item corresponding to the term after the online concierge system received a search including the prefix received during a different specific time interval and a number of prior searches for items offered by the warehouse that included the prefix and the term received by the online concierge system during the different specific time interval.

14. A computer program product comprising a non-transitory computer readable storage medium having instructions encoded thereon that, when executed by a processor, cause the processor to:
access a conversion model that was generated by:
obtaining training data comprising a plurality of examples, each example comprising a combination of a warehouse, a term, a prefix received in a prior search, a corresponding set of features of the combination, and a label applied to each example indicating whether an item corresponding to the term was included in a prior order received by an online concierge system;
training a plurality of decision trees where a result of a loss function of a decision tree is an input to a subsequent decision tree, where the conversion model is configured to receive a prefix from a search, the term, the warehouse, and a set of features of a combination of the prefix from the search, the term, and the warehouse and to generate a predicted probability of the item corresponding to the term being included in an order received by the online concierge system;
for each of a plurality of the examples of the training data:
applying a decision tree to the combination of the warehouse, the term, the prefix received in the prior search, and the corresponding set of features of the combination;
iteratively propagating a result of one or more loss functions from the decision tree to the subsequent decision tree for the plurality of decision trees, one or more of the error terms based on a difference based on a difference between a label applied to the example and the predicted probability of the item corresponding to the term being included in an order received by the online concierge system; and
stopping the propagation after one or more halting criteria are satisfied;
receive, at an online concierge system, a request for an order that identifies a specific warehouse;
receive a prefix for a search for the requested order from the user;
select a set of candidate terms based on the prefix for the search for the requested order;
apply the conversion model to each combination of specific warehouse, prefix for the search for the requested order, and candidate term to generate a predicted probability of an item corresponding to a candidate term being included in the requested order; and
display candidate terms to the user in an order based on the predicted probabilities of items corresponding to candidate terms being included in the requested order.

15. The computer program product of claim 14, wherein display candidate terms to the user in the order based on the predicted probabilities of item corresponding to candidate terms being included in the requested order comprises:
rank the candidate terms based on corresponding probabilities of the item corresponding to the candidate term being included in the requested order so candidate terms with higher corresponding probabilities have higher positions in the ranking; and
display the candidate terms to the user in an order based on the rank.

16. The computer program product of claim 14, wherein display candidate terms to the user in the order based on the predicted probabilities of item corresponding to candidate terms being included in the requested order comprises:
display the candidate terms to the user in a suggestion region displayed proximate to an input element that received the prefix for the search for the requested order.

17. The computer program product of claim 14, wherein a feature of the set comprises a value determined from a number of previously received orders identifying the warehouse including the item corresponding to the term after the online concierge system received a search including the prefix and a number of prior searches for items offered by the warehouse that included the prefix and the term received by the online concierge system.

18. The computer program product of claim 14, wherein the value comprises a ratio of the number of previously received orders identifying the warehouse including the item corresponding to the term after the online concierge system received the search including the prefix to the number of prior searches for items offered by the warehouse that included the prefix and the term received by the online concierge system

19. The computer program product of claim 14, wherein a feature of the set comprises a value determined from a number of previously received orders identifying the warehouse including the item corresponding to the term after the online concierge system received a search including the prefix received during a specific time interval and a number of prior searches for items offered by the warehouse that included the prefix and the term received by the online concierge system during the specific time interval and another feature of the set comprises an additional value determined from a number of previously received orders identifying the warehouse including the item corresponding to the term after the online concierge system received a search including the prefix received during a different specific time interval and a number of prior searches for items offered by the warehouse that included the prefix and the term received by the online concierge system during the different specific time interval.

20. The computer program product of claim 14, wherein a feature of the set is selected from a group consisting of: a rate at which users selected the term in prior searches of items offered by the warehouse including the prefix, an indication whether the prefix fully matches the term, a percentage of the term matched by the prefix, a position in a suggestion region where the term was displayed when the prefix was received, and any combination thereof.
